(19) United States
(12) Patent Application Publication
(10) Pub. No.: US 2002/0065137 A1
(43) Pub. Date: May 30, 2002

(54) Electronic game device, data processing method and storage medium for the same

(76) Inventor: Keisuke Tonomura, Fussa-shi (JP)

Correspondence Address: FRISHAUF, HOLTZ, GOODMAN &, LANGER & CHICK, PC, 767 THIRD AVENUE, 25TH FLOOR, NEW YORK, NY, 10017-2023, US

(21) Appl. No.: 09/989,366

(22) Filed: Nov. 20, 2001

(30) Foreign Application Priority Data
Nov. 27, 2000 (JP) 2000-359687

(51) Int. Cl. A63F 13/00

(52) U.S. Cl. 463/43

(57) ABSTRACT

The present invention relates to an electronic game device, a data processing method and a storage medium for the same, which can execute an unexpected game certainly and rapidly. A digital camera obtains external environment data by using a thermometer and the like, and transmits the obtained external environment data to a portable type of electronic game device. During the game, the electronic game device suddenly reads out an image of a character corresponding to the external environment data and at least one game character relating data selected from the group consisting of a name of the character, a characteristic of the character, a color of the character, an attribute of the character and the like, from a ROM, and displays them, in accordance with the external environment data. Thereby, a user can enjoy an unexpected game.

### BACKGROUND OF THE INVENTION

1. Field of the Invention

The present invention relates to an electronic game device, a data processing method and a storage medium for the same, which are useful in applying to each type of electronic apparatus, such as a digital camera, an electronic game apparatus or the like.

2. Description of Related Art

Recently, a portable game device in which an object to be shot is simply shot by using an electronic camera to display the shot image on a display section, has been known.

However, in case of this type of portable game device, although the portable game device is widely used among children because various image processing, such as a function of creating a montage image, a function of composing an image or the like, can be carried out, this portable game device cannot sufficiently satisfy user's desire that the user wants to play the game which gives an impression to the user and uses an unexpected image.

### SUMMARY OF THE INVENTION

An object of the present invention is to provide an electronic game device, a data processing method and a storage medium which are able to play an electronic game which gives an impression to a user and becomes unexpected by using a very simple structure.

According to the present invention, in order to accomplish the above-described object, an environment data sent from the outside of an electronic game device is received. A character appearing in a game is displayed in accordance with the environment data. Further, at least one game character relating data selected from the group consisting of a name of the character, a characteristic of the character, a color of the character, an attribute of the character and a name of parameter used in the game is displayed.

### BRIEF DESCRIPTION OF THE DRAWINGS

FIG. 1 is a plan view showing the whole electronic game system according to the present embodiment;

FIG. 2 is the whole block diagram showing circuit structures of a digital camera and a portable game device which constitute the electronic game system;

FIG. 3 is a view showing a memory structure of the RAM disposed in the digital camera;

FIGS. 4A to 4D are views showing a memory structure of each ROM, such as a temperature/hidden character name conversion ROM and the like;

FIG. 5 is a view showing a memory structure of an environment/hidden character image ROM;

FIG. 6 is a view showing a memory structure of a RAM disposed in the electronic game device;

FIG. 7 is a view showing the process for the general flow which is carried out by the electronic game system in the present embodiment;

FIG. 8 is a view showing the process for shooting image and the like by the digital camera;

FIG. 9 is a view showing the process for transmitting a shot image and the like to the game device;

FIG. 10 is a view showing the process for receiving a shot image and the like by the game device;

FIG. 11 is a view showing the process for displaying a hidden character, and the like by the game device; and

FIG. 12A is a view showing a display example of a shot image soon after the shooting, and the like,

FIG. 12B is a view showing a display example of a normal game, and

FIGS. 12C to 12E are views showing each display example of the game according to the present embodiment.

### PREFERRED EMBODIMENTS OF THE INVENTION

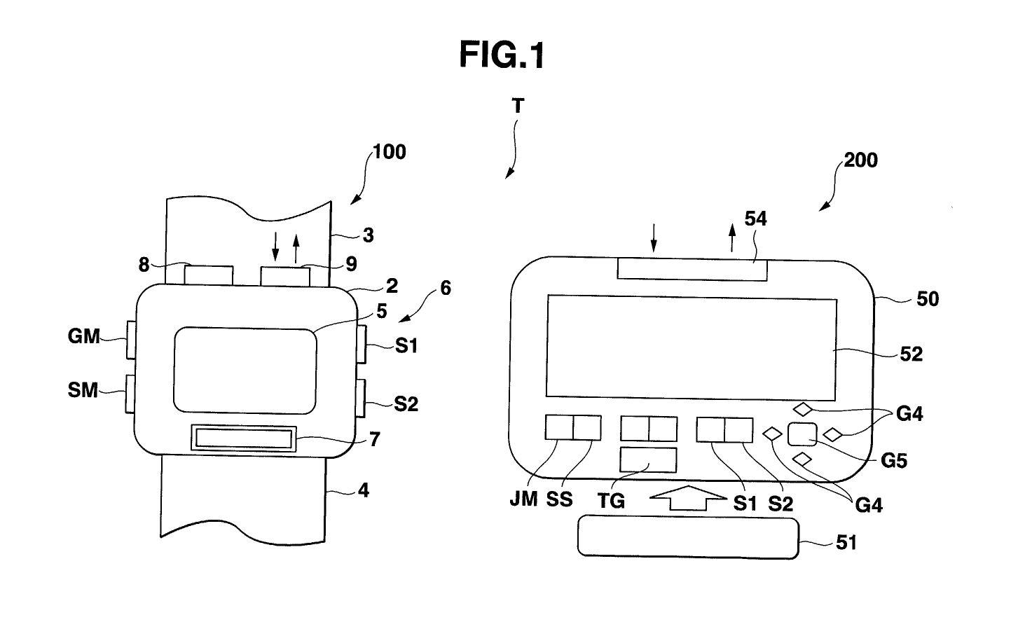

Hereinafter, an embodiment of the electronic game system according to the present invention will be explained in detail with reference to FIGS. 1 to 12E.

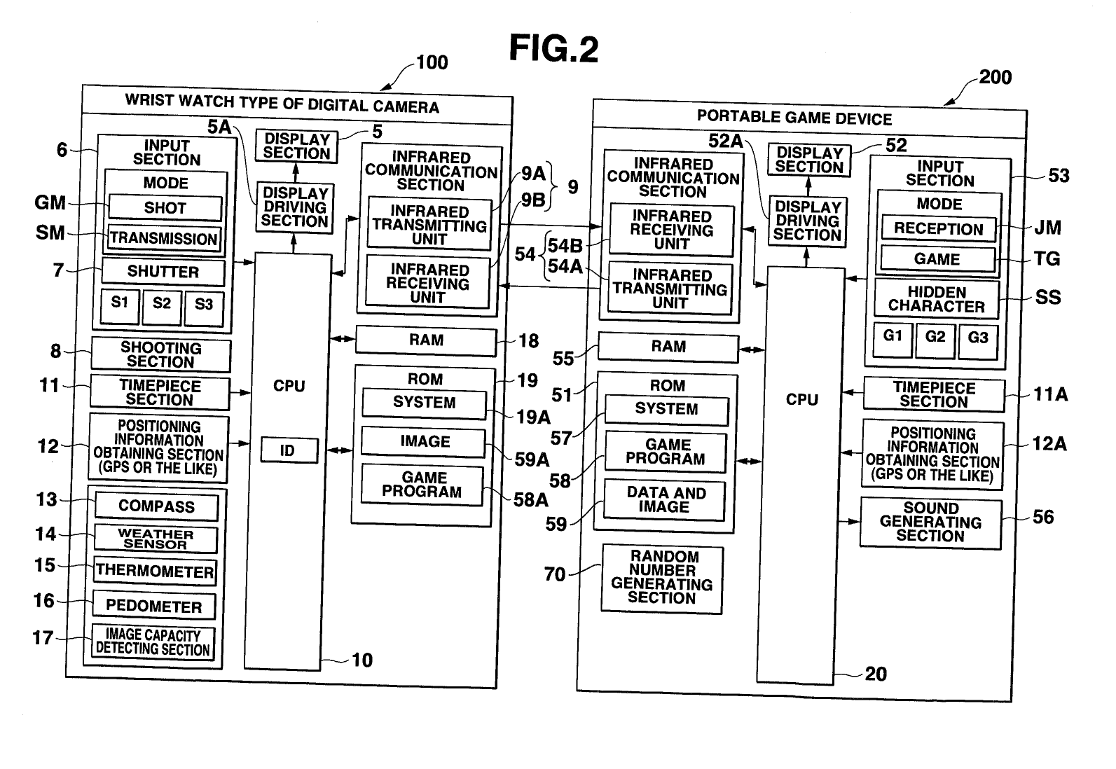

FIG. 1 shows the whole system of the electronic game system according to the present embodiment. FIG. 2 shows circuit block diagrams of a wrist watch type of digital camera and a portable game device which constitute the electronic game system.

As shown in FIG. 1, the electronic game system T comprises a wrist watch type of digital camera 100 having an environment data output device and a portable game device 200 constituting an electronic game device.

The wrist watch type of digital camera 100 comprises a camera part 2 and wrist bands 3 and 4 extending from the camera part 2. The camera part 2 comprises a display section 5 on which a shot image or various types of data are displayed, an input section 6 for being operated by a user, and the like. The input section 6 comprises key input units S1 and S2 provided on the side surface of the camera part 2, a shutter switch 7 of the camera, which is operated in the shooting, and the like. On a front end portion of the camera part 2, which is on the wrist band 3 side, a shooting section 8 and an infrared communication section 9 are provided apart from each other at a predetermined interval. The shooting section 8 shoots an object to be shot, by the switch operation of the shutter switch 7. The infrared communication section 9 transmits a shot image corresponding to the shot object, to the portable game device 200 with infrared rays in accordance with the IrDA standard.

On the other hand, the portable game device 200 comprises a game part 50 and an external ROM 51 which is attachable to and detachable from the game part 50. The game part 50 comprises a display section 52 on which the shot image transmitted from the above-described wrist watch type of digital camera 100 or various types of data are displayed, an input section 53 for being operated by a user, an infrared communication section 54 for communicating the shot image or the like with the wrist watch type of digital camera 100, and the like. The input section 53 comprises each type of operation switch G4, G5, JM and the like.

FIG. 2 is the whole block diagram showing circuit structures of a digital camera 100 and a portable game device 200 which constitute the above-described electronic game system.

A CPU 10 for controlling the whole of the digital camera 100, is connected with the display section 5, the input section 6, the shooting section 8, and the infrared communication section 9. Further, the CPU 10 is connected with a timepiece section 11, a positioning information obtaining section 12, a compass 13, a weather sensor 14, a thermometer 15, a pedometer 16, an image capacity detecting section 17, a RAM 18 and a ROM 19.

The infrared communication section 9 comprises an infrared transmitting unit 9A and an infrared receiving unit 9B.

The timepiece section 11 indicates the present time or measures the elapsed time and the like. The positioning information obtaining section 12 grasps the current position of the digital camera 100 in accordance with a GPS satellite, a beacon, FM multiplex broadcasting or the like. The compass 13 detects a current direction of the digital camera 100. The weather sensor 14 detects the weather from the condition, such as the current atmospheric pressure, rain, snow and the like. For example, when fine, cloudy or the like is detected, a pressure sensor is used as a weather sensor. In accordance with the rate of change in an atmospheric pressure detected by the pressure sensor, or the amount of change in the atmospheric pressure, fine, cloudy or the like is detected. When rain or snow is detected, a rain sensor or a snow sensor is used. The thermometer 15 detects the current temperature. The pedometer 16 measures the number of steps by counting the number of walking signals detected by an incorporated vibration sensor or the like in accordance with the walking of a user. The image capacity detecting section 17 detects the data capacity of the shot image. The timepiece section 11, the positioning information obtaining section 12, the compass 13, the weather sensor 14, the thermometer 15, the pedometer 16 and the image capacity detecting section 17 function as sections for detecting each external environment and outputting the corresponding environment data.

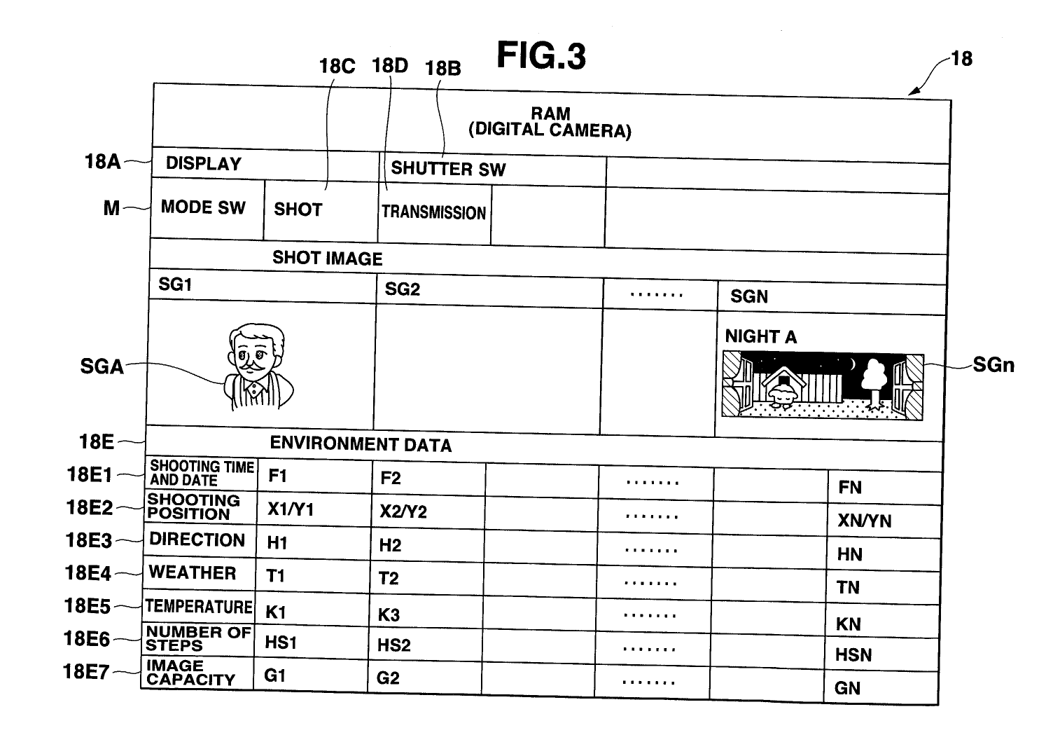

As shown in FIG. 3, the RAM 18 comprises a plurality of areas for storing various types of images and data which are used in the digital camera 100.

For example, an area 18A for display stores an image and the like to be displayed on the display section 5 therein An area 18B for shutter switch stores a data for indicating whether the shutter switch 7 is operated. In an area M for mode switch, an area 18C for shot image stores a data for indicating whether a shot image mode switch GM for shooting an object to be shot is operated. An area 18D for transmission stores a data for indicating whether a transmission mode switch SM for transmitting a shot image to the outside is operated A plurality of areas SG1 to SGN for shot image store shot images which are shot by a user.

An area 18E for environment data stores each environment data, such as shooting time and date and the like. In the area 18E for environment data, an area 18E1 for shooting time and date stores the shooting time and date indicated by the timepiece section 11. An area 18E2 for shooting position stores a positioning data corresponding to the current position, which is obtained by a GPS satellite, a beacon, FM multiplex broadcasting or the like. An area 18E3 for direction stores the current direction of the digital camera 100, which is detected by the compass. An area 18E4 for weather stores the weather relating to the conditions of the current atmospheric pressure, rain, snow and the like, which is detected by the weather sensor 14. An area 18E5 for temperature stores the current temperature detected by the thermometer 15. An area 18E6 for the number of steps stores the number of steps of a user, which is measured by the pedometer 16. An area 18E7 for image capacity detection stores the data capacity of a shot image, which is detected by the image capacity detecting section 17.

The term “shooting time and date” is a concept relating to time and date, such as morning, daytime and night (each time slot in a day), hour, minute and second (time), Oct. 30, 2000 (year, month and day), spring, summer fall and winter (seasons in a year) or the like. The term “shooting position” is a concept relating to position, such as longitude 100° east and latitude 200° (latitude and longitude), area, country, region or the like. The term “shooting direction” is a direction in which the shooting section of the digital camera 100 is directed, and is a concept including not only east, west north and south, but also an angle at which the shooting section of the digital camera 100 is directed to the sky and the ground. The term “weather” is a concept including not only the weather at the shooting time, but also the weather, for example, the weather of the day for shooting, the weather before or after the day or the like. The term “temperature” is a concept including not only the temperature at the shooting time, but also the temperature, for example, the temperature of the day for the shooting, the temperature before or after the day or the like. The term “number of steps” is a concept including not only the number of steps till the shooting, but also the number of steps, for example, the number of steps on the day for the shooting, the total number of steps from several days ago, or the like. The term “data capacity of an image” is a concept including not only the data capacity of each shot image, but also the data capacity of all of the shot images.

The ROM 19 comprises a system ROM 19A. The system ROM 19A stores a program for controlling the whole system of the digital camera 100, and various types of data.

On the other hand, like the digital camera 100, in the portable game device 200, not only the display section 52, the input section 53 and the infrared communication section 54 but also an external ROM 51, a RAM 55 and a sound generating section 56 are connected with the CPU 20 for controlling the whole portable game device 200.

The external ROM 51 comprises a system ROM 57 having the same function as the above-described system ROM 19, a game program ROM 58 for storing a game program data, and a data and image conversion ROM 59 for converting a data into a predetermined data.

The game program ROM 58 stores a program data (including the current game proceeding contents, various types of parameters relating to a character appearing the game, a name of an image to be composed, a coordinate data of the composed part and the like) which is the game contents used in the portable game device 200.

The data and image conversion ROM 59 further comprises a temperature/hidden character name conversion ROM 60, a weather/hidden character name conversion ROM 61, a temperature/hidden special skill conversion ROM 62, a weather/hidden special skill conversion ROM 63 and an environment/hidden character image conversion ROM 64.

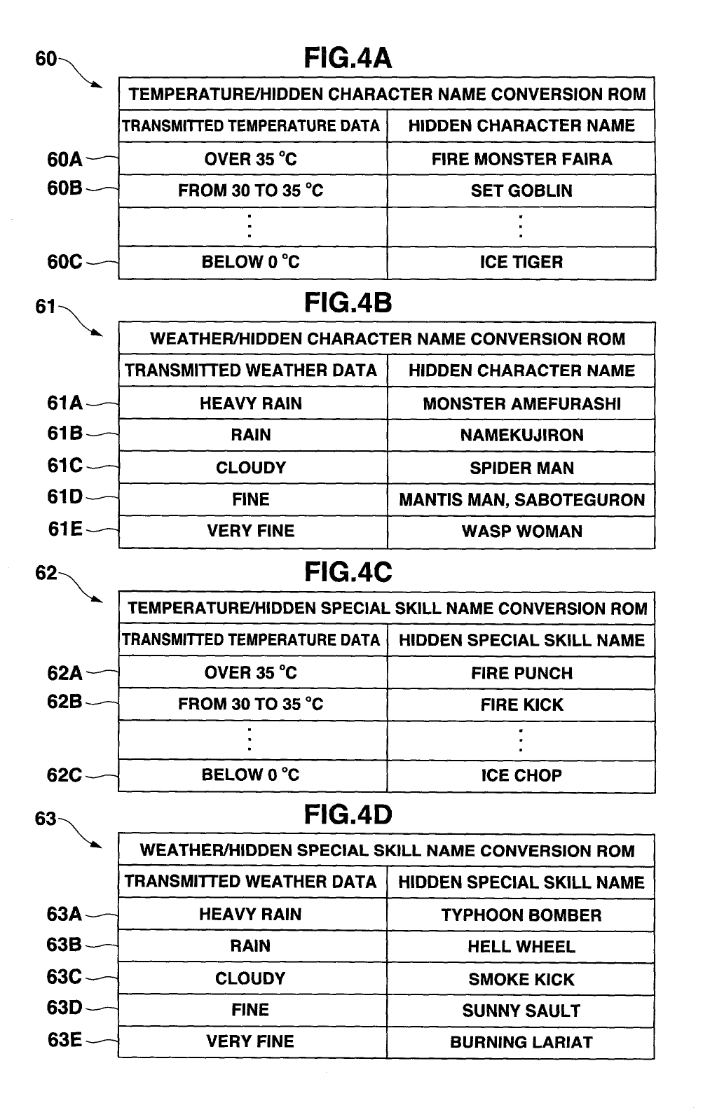

The temperature/hidden character name conversion ROM 60 is a ROM which determines the relation between the transmitted temperature data and the hidden character names in a conversion table form as shown in FIG. 4A. For example, in each area 60A to 60C showing each item “over 35° C.”, “within a range of 30 to 35° C.”, and “below 0° C.” of the “transmitted temperature data”, each “hidden character name”, which is “Fire Monster Faira”, “Sea Goblin, Sameguron”, . . . and “Ice Tiger”, is stored by relating the “hidden character name” to the transmitted temperature data.

The weather/hidden character name conversion ROM 61 is a ROM which determines the relation between the transmitted weather data and the hidden character names in a conversion table form as shown in FIG. 4B. For example, in each area 61A to 61E showing each item “heavy rain”, “rain”, “cloudy”, “fine” and “very fine” of the “transmitted weather data”, each “hidden character name” which is “Monster Amefurashi”, “Namekujiron, Maimai”, “Spider Man”, “Mantis Man, Saboteguron” and “Butterfly Woman, Wasp Woman”, is stored by relating the “hidden character name” to the transmitted weather data.

The temperature/hidden special skill name conversion ROM 62 is a ROM determines the relation between the transmitted temperature data and the hidden special skill names in a conversion table form as shown in FIG. 4C. For example, in each area 62A to 62C showing each item “over 35° C.”, “within a range of 30 to 35° C.”, . . . and “below 0° C.” of the “transmitted temperature data”, each “hidden special skill name” which is “Fire Punch”, “Fire Kick, and “Ice Chop”, is stored by relating the “hidden special skill name” to the transmitted temperature data.

The weather/hidden special skill conversion ROM 63 is a ROM which determines the relation between the transmitted temperature data and the hidden special skill names in a conversion table form as shown in FIG. 4D. For example, in each area 63A to 63E showing each item “heavy rain”, “rain”, “cloudy” “fine” and “very fine” of the “transmitted weather data”, each “hidden special skill name” which is “Typhoon Bomber”, “Hell Wheel”, “Smoke Kick”, “Sunny Sault” and “Burning Lariat”, is stored by relating the “hidden special skill name” to the transmitted weather data.

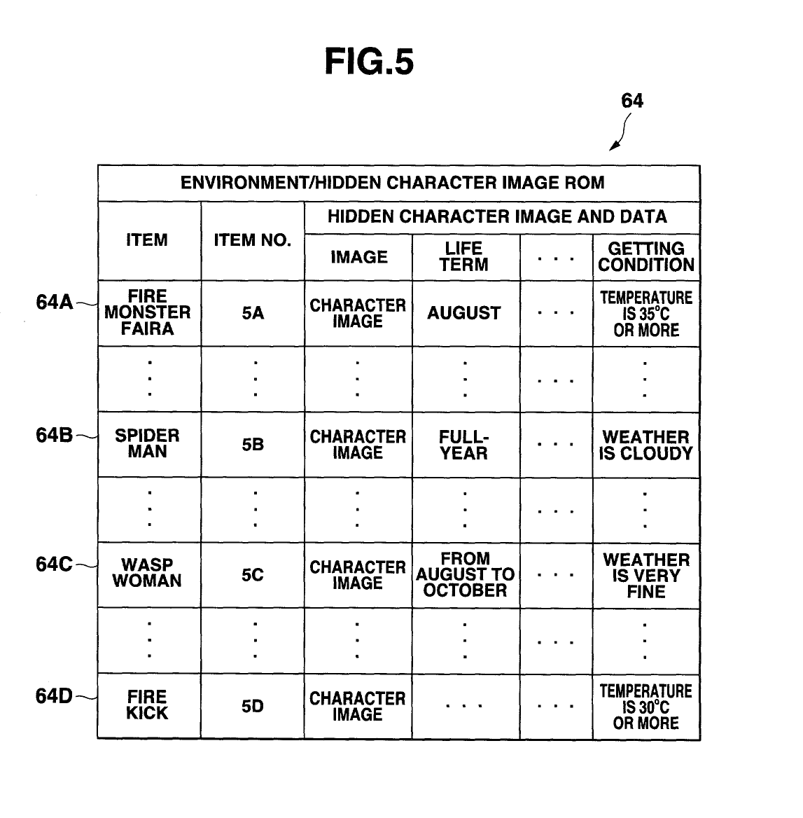

On the other hand, as shown in FIG. 5, the environment/hidden character image ROM 64 is a ROM which previously stores a plurality of hidden character images corresponding to the hidden character names and the hidden special skill names which are read out from the temperature/hidden character name conversion ROM 60, the weather/hidden character name conversion ROM 61, the temperature/hidden special skill name conversion ROM 62 and the weather/hidden special skill name conversion ROM 63. For example, in each area 64A to 64D showing each item “Fire Monster Faira”, “Spider Man”, “Wasp Woman” and “Fire Kick” of the hidden character name and the hidden special skill name, each “hidden character image” and each type of data which is related to the hidden character, such as “life term”, “active time”, “active temperature”, “active term”, “getting (obtaining) condition” and “parameter such as destruction ability” are stored by relating these images and data to the “hidden character name” and the “hidden special skill name”.

For example, in the area 64B showing an item “Spider Man” which is the hidden character name, a “hidden character image” of the “Spider Man” is stored as the “hidden character image” Further, various types of data “full-year”, “from 17:00 to 24:00”, “from 15 to 30° C.” and “cloudy” are stored as “life term”, “active time”, “active temperature” and “active term”, respectively by relating these data to the hidden character name.

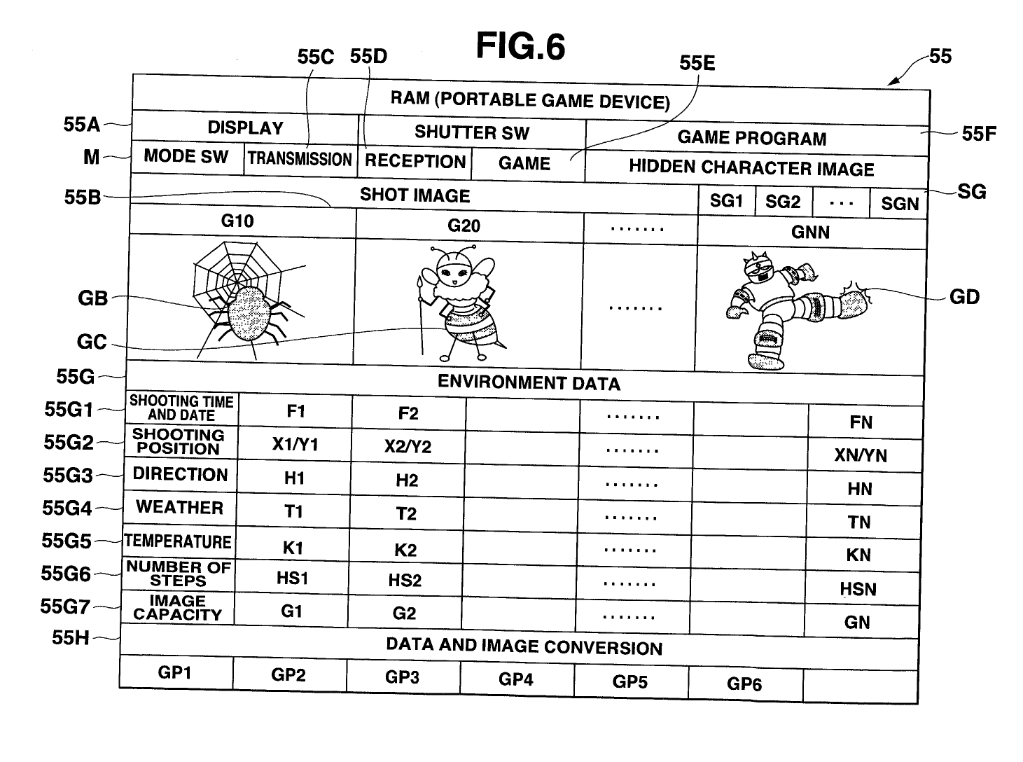

As shown in FIG. 6, the RAM 55 comprises a plurality of areas for storing various types of images and data, like the RAM 18 disposed in the digital camera 100.

For example, the RAM 55 comprises an area 55A for display, and an area M for mode switch, which includes an area 55C for transmission and an area 55D for reception. Further, the RAM 55 comprises a program area 55F for storing a game program data loaded from the game program ROM 58 in the external ROM 51, a plurality of areas SG1 to SGN for shot image, which store the shot images transmitted from the digital camera 100, a hidden character area 55B for storing the hidden character images read out from the environment/hidden character image ROM 64 and various types of data which are related to the read out hidden character, an area 55G for environment data, which stores the environment data, such as shooting time and date and the like which are transmitted from the digital camera 100, an area 55H for data and image conversion, which stores the data read out from the data and image conversion ROM 59, and the like.

The above-described area 55G for environment data comprises an area 55G1 for shooting time and date, an area 55G2 for shooting position, an area 55G3 for direction, an area 55G4 for weather, an area 55G5 for temperature, an area 55G6 for the number of steps, and an area 55G7 for image capacity detection.

The area 55H for data and image conversion, comprises a temperature/hidden character name conversion area GP1, a weather/hidden character name conversion area GP2, an environment/hidden character name conversion area GP3, a temperature/hidden special skill name conversion area GP4, a weather/hidden special skill name conversion area GP5, an environment/hidden character image area GP6 and the like.

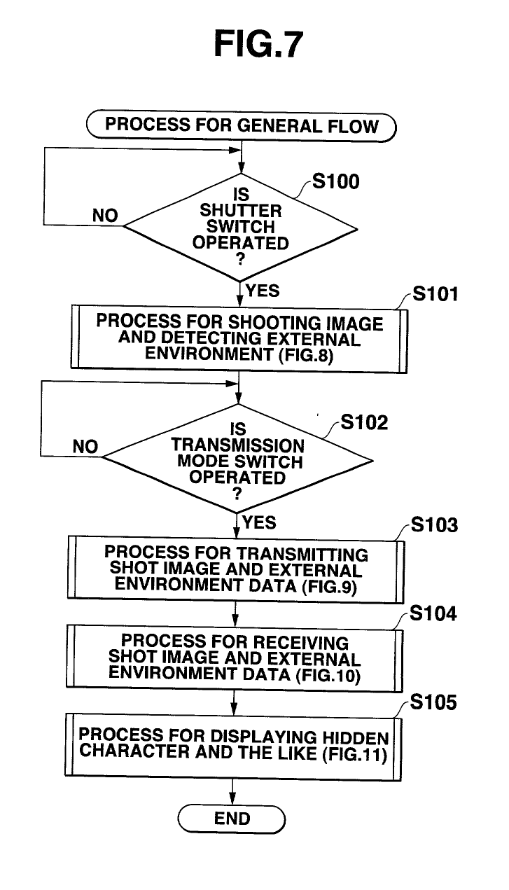

FIG. 7 shows the process for the general flow in the present embodiment.

After a power supply of the digital camera 100 and that of the game device 200 are switched on, firstly, when the shutter switch 7 of the digital camera 100 is operated (step S100), the process for shooting an object and detecting an external environment at the shooting (hereinafter, “process for shooting image and detecting external environment”) by the digital camera 100 is carried out (step S101). When the transmission switch of the digital camera 100 is operated (step S102), the process for transmitting a shot image and the external environment data from the digital camera 100 to the game device 200 (hereinafter, “process for transmitting shot image and external environment data”) is carried out (step S103). After the process for transmitting shot image and external environment data, is carried out, the process for receiving a shot image and external environment data by the game device 200 (hereinafter, “process for receiving shot image and external environment data”) is carried out (step S104). After the process for receiving shot image and external environment data, is carried out, the process for displaying a hidden character and the like in accordance with the external environment data by the game device 200 (hereinafter, “process for displaying hidden character and the like”) is carried out (step S105). When the process for displaying hidden character and the like is finished, the general flow in ended.

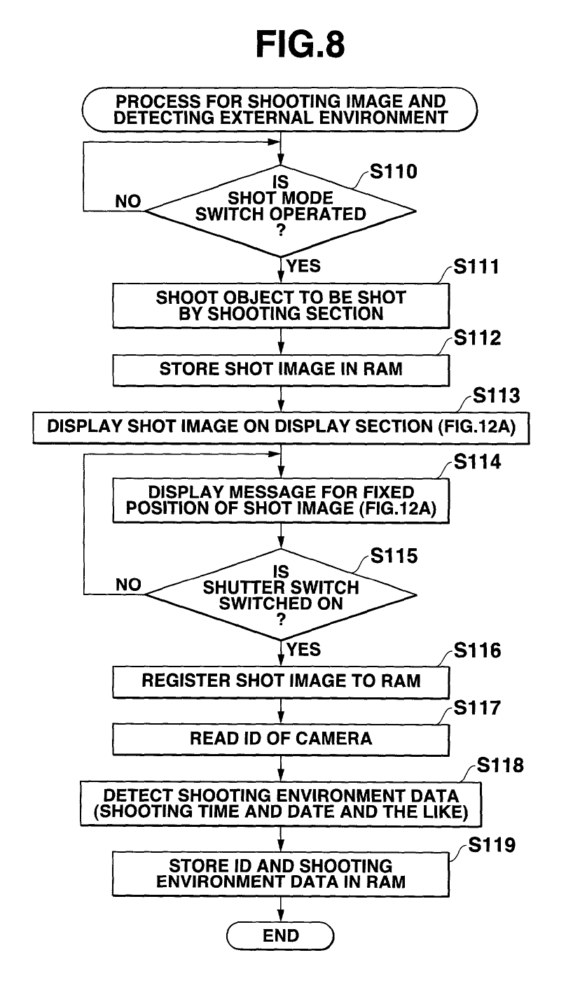

FIG. 8 shows a flow of “process for shooting image and detecting external environment” in the above-described general flow.

After a power supply of the digital camera 100 is switched on, the flow of “process for shooting image and detecting external environment” is started.

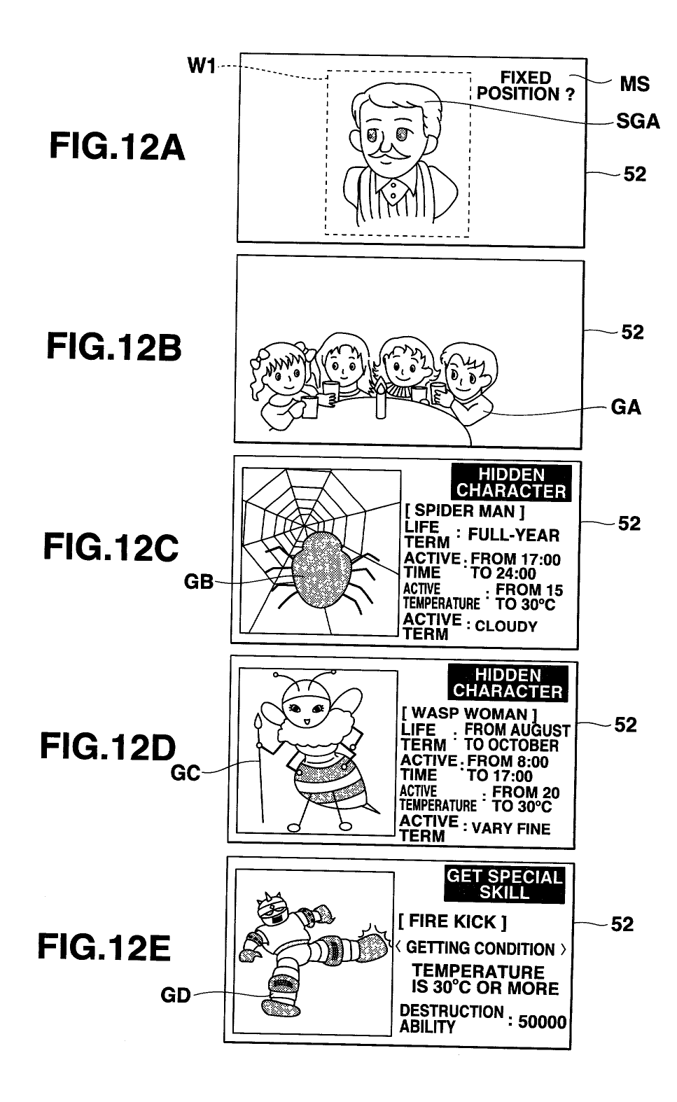

Firstly, the CPU 10 of the digital camera 100 judges whether the shot mode switch GM is operated (step S110) When it is judged that the shot mode switch GM is operated in the step S110, an object to be shot is shot by the shooting section 8 (step S111). Then, the CPU 10 reads the shot image (including a scene image) corresponding to the shot object. The read shot image is stored in one of the shot image areas SG1 to SGN of the RAM 18 (step S112). Then, as shown in FIG. 12A and FIG. 12B, the shot image SGA is displayed on the display section 5 by the display driving section 5A (step S113). In order to let a user judge whether the shot image SGA is in a fixed position of the display screen, the message MS “fixed position?” is displayed on the upper portion of the display section 52 (step S114) as shown in FIG. 12A. The user adjusts the positional relation between an object to be shot and the shooting section 8so that the shot image SGA is in the fixed position (for example, in a frame line W1 formed in a rectangle shape, which is fixedly displayed on a center portion of the display section 52) according to the message MS.

After the shot image SGA is in the fixed position of the display screen, the CPU 10 judges whether the shutter switch 7 is operated (step S115). When it is judged that the shutter switch 7 is operated, the CPU 10 reads the shot image SGA to substitutionally store the read shot image SGA in the shot image area SG1 of the RAM 18 as a definite registered shot image SGA (step S116).

Then, an ID (an identification number or a specific number assigned to the camera, for example, a serial number of the camera 100 or the like) of the camera 100 is read (step S117).

The shooting time and date, the shooting position, the direction, the weather, the temperature, the number of steps and the image capacity, which are the shooting environment data are detected by various types of sensors, such as the timepiece section 11, the positioning information obtaining section 12, the compass 13, the weather sensor 14, the thermometer 15, the pedometer 16 and the image capacity detecting section 17, respectively (step S118). The detected shooting environment data are read and then the ID and the shooting environment data are stored in an area 18E for environment data, of the RAM 18 (step S119). Then, this flow is ended.

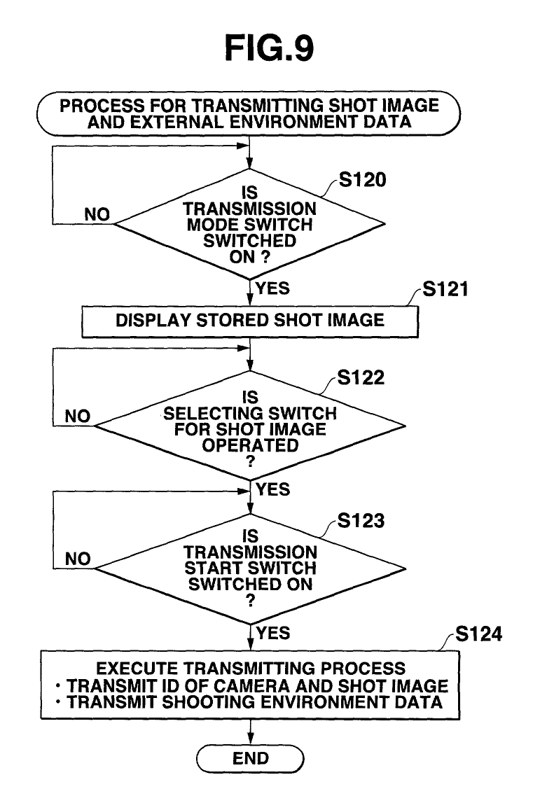

FIG. 9 shows a flow of “process for transmitting shot image and external environment data” in the above-described general flow.

Firstly, the CPU 10 of the digital camera 100 judges whether the transmission mode switch SM is switched on (step S120). When it is judged that the transmission mode switch SM is switched on in the step S120, all of the stored shot images are displayed on the display section 5 in a list or selectively (step S121). Thereby, the shot images which have been shot can be confirmed with an eye.

Next, the CPU 10 judges whether the image selecting switch S1 for selecting all of the shot images or some of the shot images is operated (step S122). Further, the CPU 10 judges whether the transmission start switch S2 is switched on (step S123). As a result, when it is judged that the transmission start switch S2 is switched on, the transmitting process for the shot image and the like is executed (step S124).

In the transmitting process, not only the ID of the camera 100 and the shot images, but also the shooting environment data, such as the shooting time and date, the shooting position, the weather, the temperature, the direction and the like, are transmitted. Then, this flow is ended.

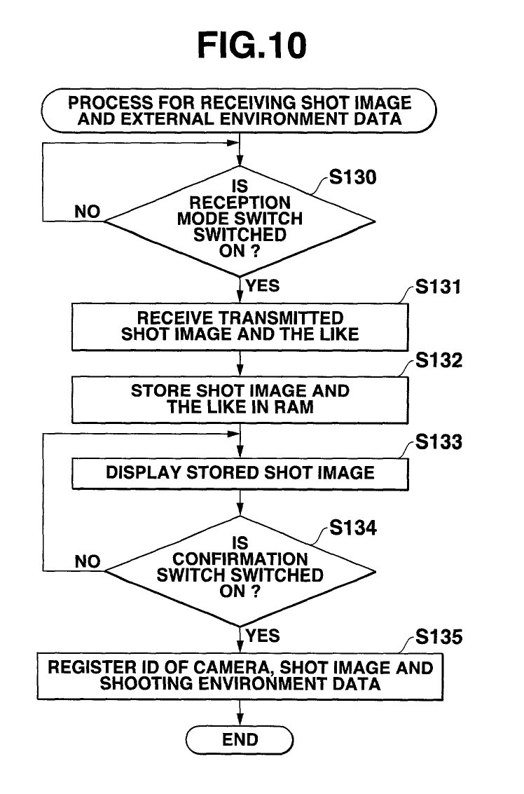

FIG. 10 shows a flow of “process for receiving shot image and external environment data” in the above-described general flow.

Firstly, the CPU 10 of the digital camera 100 judges whether the reception mode switch JM is switched on (step S130). When it is judged that the reception mode switch JM is switched on in the step S130, the shot images (including the ID of the camera 100 and the shooting environment data) and the like, which are transmitted from the digital camera 100 are received to store the transmitted shot image and the like in the area for shot image and the like of the RAM55 (step S132). The stored shot images are displayed on the display section 52 by the display driving section 52A (step S133). Thereby, the shot images which have been shot can be confirmed with an eye.

Next, the CPU 10 judges whether the confirmation switch G5 is operated (step S134). As a result, after it is judged that the confirmation switch G5 is operated, the shot images and the like are registered as shot images which are finally decided (step S135). Then, this flow is ended.

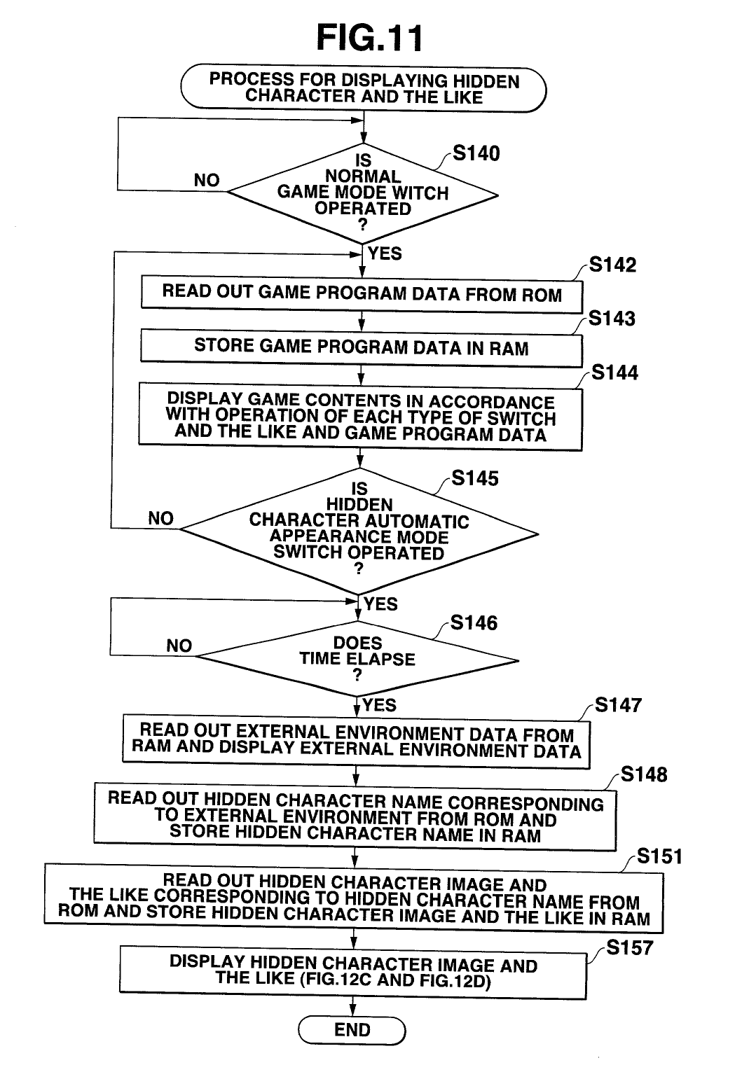

FIG. 11 shows a flow of “process for displaying hidden character and the like” in the above-described general flow.

This “process for displaying hidden character and the like” is a process for displaying a hidden character appearing in the game, a name of the hidden character and the like, before or during the game.

Firstly, the CPU 20 of the game device judges whether the normal game mode switch TG is operated (step S140). When it is judged that the normal game mode switch TG is operated, the game program data is read out from the game program ROM 58 (step S142). The read out game program data is stored in the game program area 55F of the RAM 55 (step S143). Then, when various types of switches G4 and the like are operated, as shown in FIG. 12B, the game contents (for example, a party game image GA) are displayed on the display section 52 in accordance with these operations and the game program data (step S144).

As described above, after the normal game mode switch TG is operated, the game contents are displayed on the display section 52 in accordance with the operations of the various types of switches G4 and the like and the game program data.

On the other hand, while the game is displayed, the CPU 20 of the game device judges whether a hidden character automatic appearance mode switch SS for displaying a hidden character and a name and the like of the hidden character is switched on (step S145). When it is judged that the hidden character automatic appearance mode switch SS is switched on in this step S145, the CPU 20 judges whether time elapses (step S146). The length of “lapse of time” may be predetermined time (for example, 120 seconds) which elapses since the hidden character automatic appearance mode switch SS is switched on, or random time determined in accordance with random number generated by a random number generating section 70.

When the CPU 20 of the game device judges that “time elapses”, the external environment data sent from the outside of the game device is read out, for example, “weather data”, is read out from the area 18E4 for weather, and the external environment data is displayed on the display section 52 (step S147).

Then, the hidden character name corresponding to the “weather data” which is the read out external environment data, is read out from the weather/hidden character name conversion ROM 61, and then is stored in the weather/hidden character name conversion area GP2 (step S148).

Next, the “hidden character image” and the “relating data”, corresponding to the “name” of the hidden character, which is stored in the weather/hidden character name conversion area GP1 are read out from the environment/hidden character image ROM 64. The read out “hidden character image” is stored in the hidden character area 55B (any one of areas G10 to GNN) (step S151).

These stored “hidden character image” and “relating data” are displayed on the display section 52 as shown in FIG. 12C and FIG. 12D (step S157).

For example, when a “weather data” which is an external environment data transmitted from the digital camera 100, is “cloudy” and the data of “cloudy” is stored in the RAM 55, a “hidden character name” corresponding to the data of “cloudy” is “Spider Man”. Therefore, the “hidden character image GB of Spider Man”, which corresponds to the “Spider Man” and the relating data which are related to the “Spider Man”, such as “life term”, “active time” and the like, are read out from the ROM 64. As a result, the “hidden character image GB of Spider Man” and the relating data, such as the “life term”, the “active time” and the like, are suddenly displayed on the display section 52 during the game, as shown in FIG. 12C.

When a “weather data” which is an external environment data transmitted from the digital camera 100, is “very fine” and the data of “very fine” is stored in the RAM 55, a “hidden character name” corresponding to the data of “very fine” is “Wasp Woman”. Therefore, the “hidden character image GC of Wasp Woman”, which corresponds to the “Wasp Woman”, and the relating data which are related to the “Wasp Woman”, such as “life term”, “active time” and the like, are read out from the ROM 64. As a result, the “hidden character image GC of Wasp Woman” and the relating data, such as the “life term”, the “active time” and the like are suddenly displayed on the display section 52 during the game, as shown in FIG. 12D.

When a “weather data” which is an external environment data transmitted from the digital camera, is “from 30 to 35° C.” and the data of “from 30 to 35° C.” is stored in the RAM 55, a “hidden special skill name” corresponding to the data of “from 30 to 35° C.” is “Fire Kick”. Therefore, a “hidden character image GD for showing a hidden character performing the Fire Kick” and the relating data which are related to the “Fire Kick” are read out from the ROM 64 in accordance with a “predetermined or randomly determined hidden character image GD” and the “Fire Kick” corresponding to the “hidden special skill name”. As a result, the “hidden character image GD for showing a hidden character performing the Fire Kick” and the “relating data” are suddenly displayed on the display section 52 as shown in FIG. 12E.

Then, this flow is ended.

As described above, in this embodiment, an image of a character appearing in a game, a name thereof and the like can be automatically displayed in accordance with the external environment data. Therefore, the troublesome problem that a user creates a character image and inputs a name of the character and the like can be previously prevented. Further, a character appearing in the game can be shown in a situation which is unexpected for a user.

Instead of the above-described infrared communication system, a communication system which is used by connecting a plurality of terminals may be adopted. In this case, external terminals are provided on the digital camera. Other external terminals to be connected with the external terminals of the digital camera are provided on the game device. After the external terminals of the digital camera are connected with the external terminals of the game device, a shot image which is shot by the digital camera and the external environment data are transmitted to the game device via the connected external terminals. The image of a character and the game character relating data, such as, a name of the character, a characteristic of the character and the like, are displayed in accordance with the transmitted shot image and the transmitted external environment data, like the above-described embodiment.

In the above-described embodiment, a shot image which is shot by the digital camera and the external environment data are transmitted to the game device via an infrared transmission medium. Then, an image of a character, a name of the character, a characteristic of the character and the like are displayed by using the shot image and the external environment data which are received by the game device. However, instead of the digital camera, a portable phone having a function of a telephone may be used. In this case, in accordance with a demand for distributing a shot image, which is transmitted from a user with the portable telephone, the external environment data is distributed from a distribution center to the portable telephone via a telephone line, an optical cable, such as the Internet or the like, or broadcast wave. The distributed external environment data is transmitted to the game device. By using the external environment data received by the game device, the image of a character and the game character relating data, such as a name of the character, a characteristic of the character and the like, are displayed, like the above-described embodiment.

In this embodiment, the electronic game system has a structure that the digital camera and the game device are separated from each other, and connected with each other via a communication system. However, the function of the digital camera and that of the game device which are shown in FIG. 2 may be contained in one electronic game device to provide an integrated electronic game device.

Further, various types of environment sensors, such as a timepiece section 11A, a positioning information obtaining section 12A (see FIG. 2), a compass, a weather sensor, a thermometer, a pedometer, an image capacity detecting section and the like, which are provided in the digital camera, may be provided in the game device. By using only the game device 200, the image of a character and the game character relating data, such as a name of the character, a characteristic of the character and the like, may be displayed in accordance with the output data from these sensors like the above-described embodiment.

In this embodiment, an electronic game is played by using the portable game device 200. However, the image of a character and the game character relating data, such as, a name of the character, a characteristic of the character and the like, may be displayed by using an installed game device like the above-described embodiment.

Further, in this embodiment, an image of a character, a name of the character, a characteristic of the character and the like may be displayed by a portable telephone type of or a body attachment type of digital camera, instead of the wrist watch type of digital camera 100.

Further, in this embodiment, an image of a character, a name of the character, a characteristic of the character and the like are displayed in accordance with each value, such as a temperature and the like, which is the external environment data, that is, “numeral data” However, a letter, a symbol or the like may be displayed in accordance with the “numeral data”. Moreover, at least one game character relating data selected from the group consisting of a color of a character, and an attribute of the character and a name of a parameter used in the game may be automatically displayed, in addition to an image of the character, a name of the character, a characteristic of the character and the like.

In this embodiment, the “special skill name” is used as the name of the parameter used in the game. However, the name of the parameter is not limited to this. Another name of the parameter, such as “chemistry name”, may be used.

As described above, in the electronic game device according to the present invention, while an image of a character is displayed in accordance with the external environment data sent from the outside of the electronic game device, the game character relating data, such as a name of the character and the like are certainly and rapidly displayed.

As a result, a game which is unexpected for a user can be certainly and rapidly executed in accordance with the external environment data.

What is claimed is:

1. An electronic game device comprising:
a receiving section for receiving an environment data sent from an outside of the electronic game device;
an environment data storing section for storing the environment data received by the receiving section; and
a display control section for displaying a character appearing in a game, in accordance with the environment data stored in the environment data storing section and for displaying at least one game character relating data selected from the group consisting of a name of the character, a characteristic of the character, a color of the character, an attribute of the character and a name of parameter used in the game.

2. The electronic game device as claimed in claim 1, further comprising:
a data storing section for relating the game character relating data displayed by the display control section, to the character appearing in the game and for storing the game character relating data; and
a data display control section for displaying the game character relating data stored in the data storing section and the character on a display section.

3. The electronic game device as claimed in claim 1, further comprising:
a game program storing section for storing a game program data; and
a data display control section for displaying the character appearing in the game, on a display section in accordance with the environment data stored in the environment data storing section, and displaying the game character relating data in accordance with the environment data, while the game is executed in accordance with the game program data stored in the game program storing section.

4. The electronic game device as claimed in claim 3, wherein the display control section comprises:
an operation section for being manually operated by a user; and
a hidden character display control section for displaying a hidden character appearing in the game, on the display section in accordance with the environment data stored in the environment data storing section, and displaying the game character relating data in accordance with the environment data, after a predetermined time elapses since the operation section is manually operated while the game is executed.

5. The electronic game device as claimed in claim in 1, wherein the environment data is a data which is detected by a detecting section for detecting at least one data selected from the group consisting of a direction, weather, a temperature and an amount of light.

6. A data processing method for being used in an electronic game device, comprising the steps of:
receiving an environment data sent from an outside of the electronic game device;
storing the environment data received by the step of receiving; and
displaying a character appearing in a game, in accordance with the environment data stored by the step of storing the environment data, and displaying at least one game character relating data selected from the group consisting of a name of the character, a characteristic of the character, a color of the character, an attribute of the character and a name of a parameter used in the game.

7. The data processing method as claimed in claim 6, further comprising the steps of:
relating the game character relating data displayed by the step of displaying at least one game character relating data, to the character appearing in the game, and storing the game character relating data; and
displaying the game character relating data stored by the step of storing the game character relating data, and the character.

8. The data processing method as claimed in claim 6, further comprising the step of:
displaying the character appearing in the game, on a display section in accordance with the environment data stored by the step of storing the environment data, and displaying the game character relating data in accordance with the environment data, while a game program storing section which stores a game program data is accessed and the game is executed in accordance with the game program data stored in the game program storing section.

9. The data processing method as claimed in claim 8, wherein the step of displaying comprises the step of:
displaying a hidden character appearing in the game, on the display section in accordance with the environment data stored by the step of storing the environment data, and displaying the game character relating data in accordance with the environment data, after a predetermined time elapses since an operation section for being manually operated by a user is manually operated while the game is executed.

10. The data processing method as claimed in claim 6, the environment data is at least one data selected from the group consisting of a direction, weather, a temperature and an amount of light.

11. A storage medium storing a program therein, which is executable by a computer for controlling an electronic game device, the program comprising:
a first program code of receiving an environment data sent from an outside of the electronic game device;
a second program code of storing the environment data received by executing the first program code; and
a third program code of displaying a character appearing in a game, in accordance with the environment data stored by executing the second program code, and displaying at least one game character relating data selected from the group consisting of a name of the character, a characteristic of the character, a color of the character, an attribute of the character and a name of parameter used in the game.

12. The storage medium as claimed in claim 11, wherein the program further comprises:
a fourth program code of relating the game character relating data displayed by executing the third program code, to the character appearing in the game and storing the game character relating data; and
a fifth program code of displaying the game character relating data stored by executing the fourth program code and the character on a display section.

13. The storage medium as claimed in claim 11, wherein the program further comprises:
a sixth program code of displaying the character appearing in the game, in accordance with the environment data stored by executing the second program code, and displaying the game character relating data in accordance with the environment data, while a game program storing section which stores a game program data is accessed and the game is executed in accordance with the game program data stored in the game program storing section.

14. The storage medium as claimed in claim 13, wherein the sixth program data comprises:
a program code of displaying a hidden character appearing in the game, in accordance with the environment data stored by executing the second program code, and displaying the game character relating data in accordance with the environment data, after a predetermined time elapses since an operation section for being manually operated by a user is manually operated while the game is executed.

15. The storage medium as claimed in claim 11, wherein the environment data is at least one data selected from the group consisting of a direction, weather, a temperature and an amount of light.
